(19) United States
(12) Patent Application Publication
(10) Pub. No.: US 2018/0330341 A1
(43) Pub. Date: Nov. 15, 2018

(54) ACCESS TO DETAILED RECEIPTS FROM ACCOUNT STATEMENTS

(71) Applicant: Sezzle, Inc., Minneapolis, MN (US)

(72) Inventors: Charles Ghassan Youakim, Minneapolis, MN (US); Paul Victor John Paradis, Minneapolis, MN (US)

(21) Appl. No.: 15/592,474

(22) Filed: May 11, 2017

(51) Int. Cl. G06Q 20/04; G06F 17/30; H04L 29/06

(52) U.S. Cl. CPC G06Q 20/0453; G06F 17/30887; H04L 63/18; H04L 63/0838; H04L 63/10; H04L 63/062

(57) ABSTRACT

A secure receipt access to management system accepts requests for receipt information and provides authentication of presenting the information. The system can issue a one-time password to a customer when access to a receipt is requested.

### BACKGROUND

Currently, financial statements (e.g., bank statement, credit card statement) present transactions in a way that can lead to confusion. Often times, it can be difficult to decipher details with respect to a transaction. Insufficient details can lead to frustration and incorrect reversals of transactions.

### SUMMARY

A secure receipt access to management system accepts requests for receipt information and provides authentication of presenting the information.

### BRIEF DESCRIPTION OF THE DRAWINGS

FIG. 1 is a flow diagram illustrating operation of a secure receipt access management system.

FIG. 2 is a block diagram illustrating components of the secure receipt access management system.

FIG. 3 is a flow diagram of a method for handling customer information.

FIG. 4 is a flow diagram of a method for handling receipt information.

FIG. 5 is a flow diagram of a method for enabling access to electronic receipts.

### DESCRIPTION OF THE PREFERRED EMBODIMENTS

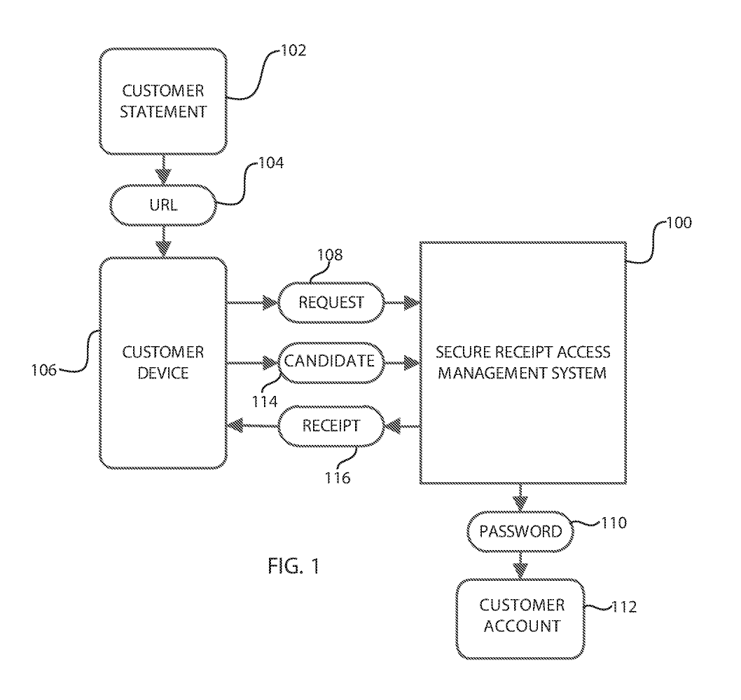

FIG. 1 is a block diagram of a secure receipt access management system 100. As illustrated, a user can easily access receipts based on information in a customer statement 102. In one example, the customer statement 102 can include information such as a merchant, description of goods and/or services, an amount and an access indicator. In one embodiment, the access indicator is a uniform resource locator (URL) 104 that provides direct access to the secure receipt access management system 100. One example access indicator includes printing information on a bank account statement or the like, such as “SZ Purchase @ ACME sz.co/tXO21kA $198.23.” A customer viewing this information can enter the URL 104 (e.g., “sz.co/tXO21kA”) into a customer device 106 and initiate a request 108 for access to a receipt uniquely associated with the URL. In response to the request 108, the secure receipt access management system can generate and issue a one-time password 110 to a customer account 112 associated with the customer. In one example, the customer account 112 can be an email account, cell phone account or other communications account for which the customer can uniquely access. Upon accessing the password 110, the customer can submit a candidate password 114 using the customer device 106 to the secure receipt access management system 100. If the candidate password 114 matches the issued password 110, the system 100 can issue the receipt 116 to the customer device 106 as requested. Issuing the receipt can include, for example, displaying an electronic copy of the receipt, transmitting information associated with the receipt, etc.

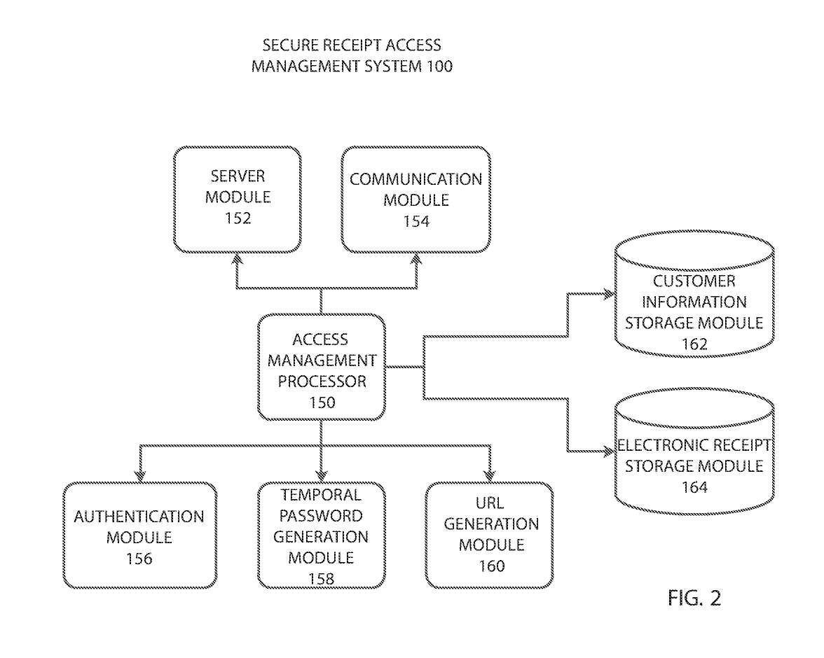

FIG. 2 is a block diagram of secure receipt access management system 100. System 100 includes an access management processor 150 operatively coupled with a server module 152, communication module 154, authentication module 156, temporal password generation module 158 and URL generation module 160. Moreover, the access management processor 150 is configured to access data with a customer information storage module 162 and an electronic receipt storage module 164. To handle access requests for access to receipts, the server module 152 is configured to handle requests using a protocol such as hypertext transfer protocol (HTTP). As discussed above, the server module can handle requests based on a URL 104.

When requests are received at the server module, the access management processor 150 uses the temporal password generation module 158 to generate a one-time, temporary password that is uniquely useful in gaining access to a particular receipt. The access management processor 150 can transmit the password to a customer using communication module 154. In particular embodiments, the communication module 154 can utilize a separate communication channel than the communication channel used to communicate between the customer and the server module 152. For example, the server module 152 may be accessed through an Internet connection using a suitable Internet communications protocol, whereas the communication module 154 can communicate through a separate channel such as email, short message service (SMS), internet accounts or others.

When a customer receives the user password through the separate communications channel, the customer can then enter a candidate password using the communication channel associated with server module 152. As such, separation of the channels associated with the server module 152 and communications module 154 can provide additional security for access to receipts. The access management processor 150 utilizes the authentication module 156 to determine whether the candidate password entered by the customer using the server module 152 matches the temporal password generated by the temporal password generation module 158. If the candidate password matches the generated password, the access management processor 150 can access the electronic receipt storage module 164 and present the receipt to the customer through the server module 152.

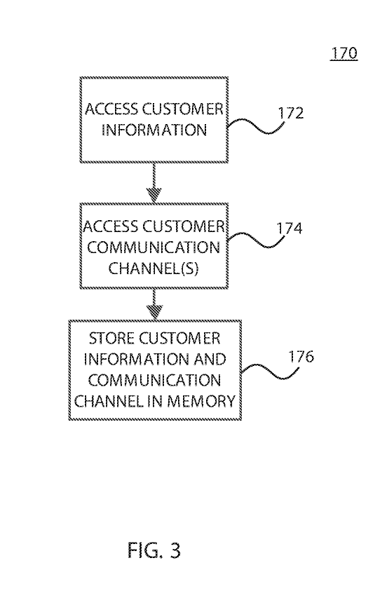

FIG. 3 is a block diagram of a method for maintaining customer information within the secure receipt access management system 100. Method 170 begins at step 172 wherein customer information is accessed. The customer information can include name, address and any other personally identifiable information associated with the customer. Next, at step 174, customer communication channels can be accessed that are associated with different channels of communication for which the access management system 100 can communicate with the user. Example access communication channel information includes mobile number, email accounts, social media accounts and others for which the customer uniquely has access. At step 176, the customer information and communication channel information of the customer is stored in memory of the secure receipt access management system 100. In particular, the customer information is stored within the customer information storage module 162 for later access.

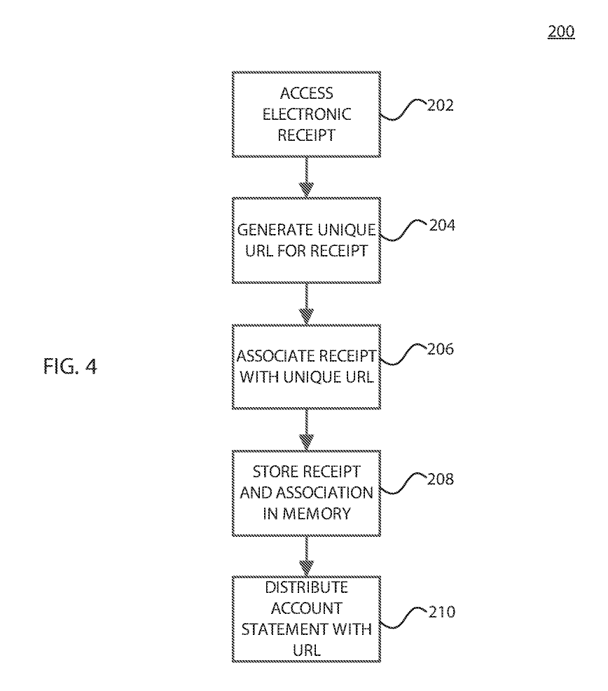

FIG. 4 is a block diagram for processing receipts using the access management system 100. In FIG. 4, method 200 begins at step 202, wherein an electronic receipt is accessed. The electronic receipt can include, for example, an image of the receipt, merchant information, customer information, item information, item price information, total price information and other information that may be useful to a user or system for understanding information related to a transaction between a customer and a merchant. At step 204, the URL generation module 160 can generate a unique URL for the receipt. In one embodiment, the URL is generated so as to include a limited number of characters. Example websites that generate shortened URLs include bit.ly. In one example, the shortened URL can be less than 10, 15, 20 or 25 characters. Next, at step 206, the receipt is associated with the unique URL that was generated in step 204. In one embodiment, the association involves using a relational database to store the association between the electronic receipt information and the unique URL for the electronic receipt. Once the association is generated, method 200 proceeds to step 208, wherein the receipt and association of the receipt and URL are stored in memory. Upon a statement being generated, the URL information can be distributed such that the customer will have easy access to the URL at step 210.

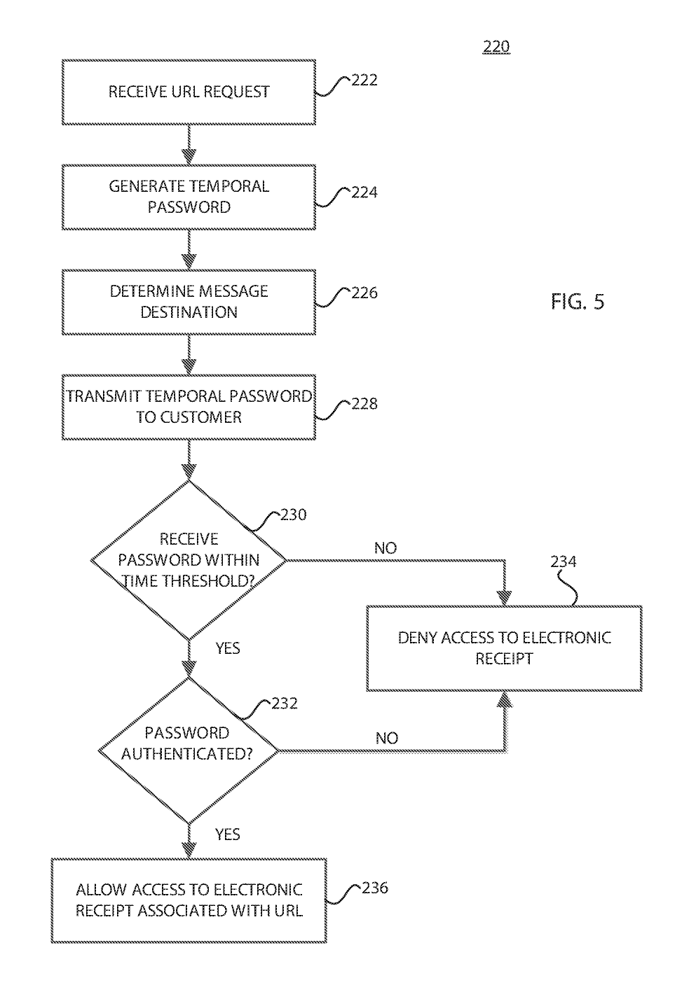

Once a customer receives the URL and wishes to access the electronic receipt associated with the URL, method 220 of FIG. 5 can be instituted in order to allow access to the electronic receipt. At step 222, a URL request can be received, for example at the server module 152. The access management processor 150 can generate a temporal password using the temporal password generation module 158 at step 224. Once the password is generated, the access management processor 150 can access the customer information storage module 162 in order to determine a message destination for the password. Once the destination is determined, the temporal password is transmitted to the destination (e.g., with an SMS message) at step 228. At step 230, it is determined whether or not a candidate password is received within a particular time threshold. For example, the customer may have one minute, two minutes, five minutes, ten minutes, etc. to enter the candidate password so as to access the receipt. At step 232, if a password has been received, the password is verified. If the password has not been received within the time threshold, access to the receipt is denied at step 234. Returning to step 232, if the password is not authenticated, access to the electronic receipt will also be denied. However, if the candidate password matches the temporal password generated, access to the electronic receipt associated with the URL is allowed at step 234.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A secure receipt management system, comprising:
a receipt storage module storing a plurality of receipts indicative of transactions between a customer and a merchant, each receipt continuing product information, merchant information and amount information associated with a transaction;
a uniform resource locator (URL) generation module generating unique URL addresses for each of the plurality of receipts;
a server module receiving requests for access to a specified receipt using a specified URL associated with the specified receipt of the unique URL addresses through a first communication channel from a customer;
a temporal password generation module generating unique passwords upon the server module receiving a request for access to the specified receipt;
a communication module transmitting a unique password to the customer through a second communication channel that is separate from the first communication channel; and
an authentication module receiving a candidate password through the first communication channel and authenticating the customer by comparing the candidate password and the unique password, wherein upon the customer being authenticated, the server module provides access to the specified receipt.

2. The system of claim 1, wherein the receipt storage module stores a receipt image for each of the plurality of receipts.

3. The system of claim 1, where the unique URL addresses are less than 20 characters.

4. The system of claim 1, further comprising a customer information storage module storing information associated with a plurality of customers.

5. The system of claim 1, wherein the first communications channel is an internet communications channel.

6. The system of claim 1, wherein the second communications channel is a short message service channel.

7. The system of claim 1, wherein the second communications channel is an email communications channel.

8. The system of claim 1, wherein the authentication module determines if the candidate password has been received within a particular time period and, if the candidate password is not received within the particular time period, access to the specified receipt will be denied.

9. The system of claim 1, wherein the authentication module will deny access to the receipt if the candidate password does not match the unique password.

10. A method of managing access to electronic receipts, comprising:
storing a plurality of receipts indicative of transactions between a customer and a merchant, each receipt continuing product information, merchant information and amount information associated with a transaction;
generating a unique uniform resource locator (URL) addresses for each of the plurality of receipts;
receiving requests for access to a specified receipt using a specified URL associated with the specified receipt of the unique URL addresses through a first communication channel from a customer;
generating unique passwords upon receiving a request for access to the specified receipt;
transmitting a unique password to the customer through a second communication channel that is separate from the first communication channel; and
receiving a candidate password through the first communication channel and authenticating the customer by comparing the candidate password and the unique password, wherein upon the customer being authenticated, access is provided to the specified receipt.

11. The method of claim 10, wherein a receipt image is stored for each of the plurality of receipts.

12. The method of claim 10, where the unique URL addresses are less than 20 characters.

13. The method of claim 10, further comprising storing information associated with a plurality of customers.

14. The method of claim 10, wherein the first communications channel is an internet communications channel.

15. The method of claim 10, wherein the second communications channel is a short message service channel.

16. The method of claim 10, wherein the second communications channel is an email communications channel.

17. The method of claim 10, further comprising determining if the candidate password has been received within a particular time period and, if the candidate password is not received within the particular time period, access to the specified receipt will be denied.

18. The method of claim 10, further comprising denying access to the receipt if the candidate password does not match the unique password.
